(19) United States
(12) Patent Application Publication
(10) Pub. No.: US 2025/0103013 A1
(43) Pub. Date: Mar. 27, 2025

(54) MULTI-VARIANT CONTROL SYSTEM FOR AN INDUSTRIAL FACILITY

(71) Applicants: X-energy, LLC, Rockville, MD (US); North Carolina State University

(72) Inventors: Andy RIVAS, Raleigh, NC (US); Gregory DELIPEI, Raleigh, NC (US); Jia HOU, Cary, NC (US); Ian DAVIS, Severna Park, MD (US); Satyan BHONGALE, Boise, ID (US)

(73) Assignees: X-energy, LLC, Rockville, MD (US); North Carolina State University, (omitted)

(21) Appl. No.: 18/786,017

(22) Filed: Jul. 26, 2024

Related U.S. Application Data
(60) Provisional application No. 63/529,462, filed on Jul. 28, 2023.

(51) Int. Cl. G05B 13/04; G05B 13/02

(52) U.S. Cl. CPC G05B 13/041; G05B 13/0265

(57) ABSTRACT

The present disclosure is directed to a multi-variant control system for an industrial facility. In one form of a method, a processor monitors a behavior of a distributed control system with respect to at least a set of uncontrolled variables, a set of controlled variables, and a set of monitored variables; trains a model based on the monitored behavior utilizing at least one of artificial intelligence or machine learning; and identifies, based on the model, a subset of controlled variables for optimization. Further, the processor monitors a behavior of the industrial facility without the use of the distributed control system; optimizes, based on the monitored behavior, the subset of controlled variables to obtain a target result and restrict variation of values of the set of monitored values; and executes a control system for the industrial facility based on the optimization of the subset of controlled variables.

### RELATED APPLICATIONS

The present application claims priority to U.S. Provisional Patent Application No. 63/529,462 (still pending), filed Jul. 28, 2023, the entirety of which is hereby incorporated by reference.

The present invention was made with government support under DE-NE0009040 awarded by the Department of Energy. The government has certain rights in this invention.

### BACKGROUND

Industrial facilities often include conventional control systems that utilize one-to-one relationships between sensors and actuators to control operations within the facility. For example, an industrial facility may control an amount of power that a turbine generates based on a one-to-one relationship between a control sensor and an actuator that adjusts a throttle of the turbine. When the control sensor determines that the amount of power that the turbine generates exceeds a threshold, the actuator may decrease the throttle to the turbine until the amount of power from the turbine drops below the threshold regardless of operations at other portions within the facility.

With the increased complexity of industrial facilities such as nuclear power plants, more advanced control systems are desirable that are able to control features within a facility utilizing a multi-variant approach that utilizes both direct and indirect relationships between different operations at the facility.

### SUMMARY

Implementations of the present disclosure utilize artificial intelligence and/or machine learning to identify relationships between different operations at an industrial facility and implement a more intelligent multi-variant control system at the industrial facility. By utilizing indirect relationships between controlled features in addition to direct relationships between controlled features, multi-variant control systems are able to more efficiently attain a desired target associated with the industrial facility, such as more efficiently attaining a desired power output at a nuclear power plant.

In one aspect, the present disclosure provides a method. In one form of the method, a processor of a control system monitors a behavior of a distributed control system of an industrial facility with respect to at least a set of uncontrolled variables, a set of controlled variables, and a set of monitored variables; trains a model of the behavior of the distributed control system based on the monitored behavior of the distributed control system, the processor utilizing at least one of artificial intelligence or machine learning to train the model; and identifies, based on the model, a subset of controlled variables of the set of controlled variables for optimization.

Further, the processor monitors a behavior of the industrial facility without the use of the distributed control system with respect to at least the subset of controlled variables; optimizes, based on the monitored behavior of the industrial facility without the use of the distributed control system, the subset of controlled variables to obtain a target result and restrict variation of values of the set of monitored values during a change in one or more values of the uncontrolled variables; and executes a control system for the industrial facility based on the optimization of the subset of controlled variables.

In another aspect, the present disclosure provides a control system. In one form, the control system comprises a memory configured to store computer readable instructions; and a processor configured to executed the computer readable instructions stored in the memory.

The processor is further configured to monitor a behavior of a distributed control system of an industrial facility with respect to at least a set of uncontrolled variables, a set of controlled variables, and a set of monitored variables; train a model of the behavior of the distributed control system based on the monitored behavior of the distributed control system utilizing at least one of artificial intelligence or machine learning to train the model; and identify, based on the model, a subset of controlled variables of the set of controlled variables for optimization.

The processor is further configured to monitor a behavior of the industrial facility without the use of the distributed control system with respect to at least the subset of controlled variables; optimize, based on the monitored behavior of the industrial facility without the use of the distributed control system, the subset of controlled variables to obtain a target result and restrict variation of values of the set of monitored values during a change in one or more values of the uncontrolled variables; and execute a control system for the industrial facility based on the optimization of the subset of controlled variables.

### BRIEF DESCRIPTION OF THE DRAWINGS

FIG. 1 is a block diagram of one form of a control scheme for an industrial facility that utilizes a control variable optimization (CVO) framework having multi-variant control for a set of controlled variables.

FIG. 2 is a flow chart of one form of a method for generating a control scheme for an industrial facility and implementing the control scheme at the industrial facility.

### DETAILED DESCRIPTION

The present disclosure is directed to a control system for an industrial facility that utilizes a control variable optimization (CVO) framework having multi-variant control for a set of optimized controlled variables. As discussed below, control systems of the present disclosure are able to provide a desired target (e.g., electric output in a nuclear power plant) while minimizing a variation in selected monitored variables that must be kept within pre-established operational thresholds.

In the present disclosure, in relation to industrial facilities such as a nuclear power plant, uncontrolled variables are variables that are not directly controllable by an operator at the industrial facility and can change throughout an operation such as a fuel cycle without operator intervention. One example of an uncontrolled variable is ambient temperature. Controlled variables are variables that operators at the industrial facility can directly control and change with operator or distributed control system (DCS) intervention. One example of a controlled variable is a control rod position within a nuclear reactor. Finally, monitored variables are variables that have pre-defined thresholds that if exceeded would result in the initiation of a protection system. Examples of monitored variables are a power level of a nuclear reactor or a pressure level at nuclear reactor.

Distributed control systems are generally computerized control systems for an industrial facility in which controllers are distributed throughout the facility to directly control various operations at the industrial facility. Current distributed control systems are effective in maintaining a desired target, but they do not guarantee that monitored variables always remain close to their optimal values in response to changes or perturbations of uncontrolled variables. One reason for this is that current distributed control systems are based on a one-to-one relationship between proportional-integral-derivative (PID) monitored variables and controlled variables. In contrast, forms of a control system described in the present disclosure provide a framework for control variable optimization in industrial facilities such as nuclear power plants that is relevant to both reactor operators and instrumentation and control engineers, where the framework provides multi-variant optimal control strategies based on multi-variant interactions among parameters that cannot be included with conventional PID controllers.

In particular, forms of a control variable optimization (CVO) framework discussed in the present disclosure provide an optimized set of controlled variables that minimizes a variation in selected monitored variables when an industrial facility is exposed to a set of changes in the uncontrolled variables, without violating any of the pre-established operational thresholds, and achieves a desired target, such as a level of power.

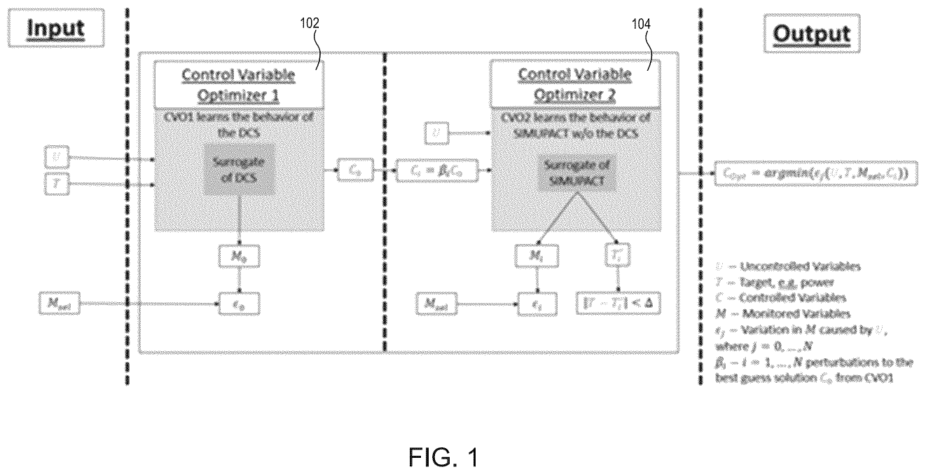

FIG. 1 is a block diagram of one form of a control scheme for an industrial facility that utilizes a CVO framework having multi-variant control for a set of optimized controlled variables. The CVO framework includes a first control variable optimizer 102 and a second control variable optimizer 104. The first and second control variable optimizers 102, 104 may be implemented by one or more servers or other computing devices in which computer readable instructions are stored in a memory and executed by CPU or other processing circuitry.

In the overall control scheme illustrated in FIG. 1, the input is a set of uncontrolled variables U, a target T, such as electrical power, and a selected set of monitored variables Mₛₑₗ. An output of the control scheme will be the subset of optimized control variables C_{Opt} that will minimize variation in the monitored variables, when the system is exposed to a set of uncontrolled variables whose values change or are perturbed, without violating pre-established operational thresholds and achieve the target, such as a desired level of power. In FIG. 1, subscript i refers to the inputs and outputs of the second control variable optimizer 104 and range from [1,N], where subscript j includes the response from the first control variable optimizer 102 and thus range from [0,N] to include a distributed control system (DCS) response.

The first control variable optimizer 102 monitors and analyzes performance of a distributed control system of an industrial facility. The first control variable optimizer 102 learns how the distributed control system operates and identifies a subset of controlled variables for optimization. In some implementations, the first control variable optimizer 102 utilizes artificial intelligence and/or machine learning such as a feedforward neural network or linear regression to identify the subset of controlled variables for optimization.

As shown in FIG. 1, the first control variable optimizer 102 takes as input the uncontrolled variables U and the desired target T to provide the second control variable optimizer 104 with an initial determination of the subset of controlled variables C₀ for optimization.

After identifying the subset of controlled variables for optimization, the second control variable optimizer 104 optimizes the identified subset of controlled variables to provide a desired target, such as an electrical output of a nuclear power plant, while minimizing a variation in selected monitored variables that must be kept within pre-established operational thresholds. In some implementations, the second control variable optimizer 104 utilizes artificial intelligence and/or machine learning along with genetic programming to optimize the subset of controlled variables and reach the desired target.

As shown in FIG. 1, the second control variable optimizer 104 takes as input the uncontrolled variables U and a set of perturbed/changed controlled variables that are the controlled variables C₀ from the first control variable optimizer 102. These perturbations/changes in the controlled variables are used to monitor and analyze possible control variables in order to find the subset of controlled variables C_{Opt} for optimization, as discussed in more detail below.

Providing the second control variable optimizer 104 with an initial determination of the subset of controlled variables for optimization allows for a model to begin searching a valid sample space with N samples to accelerate the convergence to an optimal subset of controlled variables. With β₁C₀, . . . , β_{N}C₀ sets of controlled variables, the second control variable optimizer 104 is able to explore the solution space utilizing genetic algorithm

From the N perturbations or changes, the second control variable optimizer 104 will output N sets of monitored variables Mᵢ, . . . , M_{N} that may be compared to the selected set of monitored variables to quantify the variation caused by the various perturbations, ϵᵢ, . . . , ϵ_{N}. Further, an output of the second control variable optimizer 104 provides a predicted target, such as a predicted power, that results from the perturbed controlled variables, i.e. Tᵢ′, . . . , T_{N}′. Each of these N target estimates may be compared to the desired target value, and if the absolute difference is greater than a user-defined tolerance, then the control scheme may be deemed invalid and a penalty value is assessed to ϵᵢ. After all ϵⱼ values are collected, the set of controlled variables Cⱼ that minimizes this value are deemed the optimal subset of controlled variables Cₒₚₜ given the desired target and the uncontrolled variables.

The above framework can be summarized according to the following equation, wherein an optimal subset of controlled variables are a function of uncontrolled variables, a desired target, and a set of monitored variables.

F(U,T,Mₛₑₗ)=Cₒₚₜ

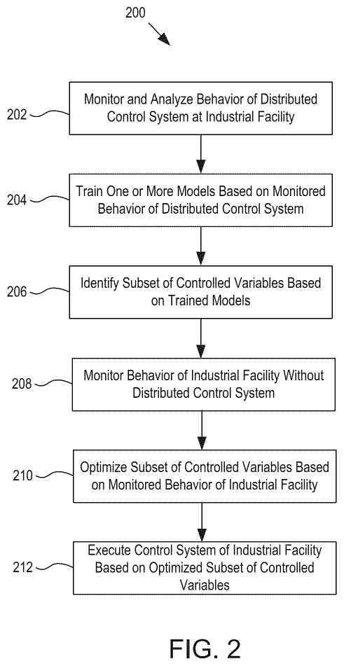

FIG. 2 is a flow chart of one form of a method 200 for generating a control scheme for an industrial facility and implementing the control scheme at the industrial facility. In some implementations, a processor executing instructions stored in memory of one or more servers acting as a control system of industrial facility may perform the elements in connection with the described method.

At step 202, a processor of a control system monitors and analyses a behavior of a distributed control system of an industrial facility with respect to at least a set of uncontrolled variables, a set of controlled variables, and a set of monitored variables.

In some implementations, where the industrial facility is a nuclear power plant for example, the set of uncontrolled variables includes at least one of an ambient temperature, a condenser pressure, a low pressure turbine efficiency, a high pressure turbine efficiency, a steam generator tube opening, or a variable speed pump degradation; the set of controlled variables includes at least one of a control rod position, a circulator speed, a feedwater pump speed, or a turbine control valve; and the monitored variables includes at least one of a reactor power, an outlet reactor pressure, an inlet reactor pressure, a steam generator outlet temperature, a steam generator outlet pressure, a steam generator inlet mass flow, and an electrical power.

In some implementations, the processor of the control system analyzes a behavior of the distributed control system by holding uncontrolled variables constant, changing a desired output of the control system, and monitoring how the distributed control system changes the controlled variables to achieve the desired output. For example, in the context of a nuclear power plant, the processor may incrementally adjust a desired electrical power output, hold the uncontrolled variables constant, and then monitor how the distributed control systems changes the controlled variables to obtain the desired electrical power output over the incremental adjustments of the desired electrical output.

As part of monitoring and analyzing the behavior of the distributed control system, the processor determines a multi-variant relationship between one or more variables of the set of uncontrolled variables, the set of controlled variables, and the set of monitored variables. In some implementations, the processor determines the multi-variant relationship by utilizing artificial intelligence and/or machine learning to recognize patterns in how the distributed control system adjusts controlled variables to obtain a desired output as the desired output is incrementally changed.

Continuing with the illustrative example above in the context of a nuclear power plant where the processor of the control system incrementally adjusts a desired electrical power output, the processor of the control system of a nuclear power plant may observe relationships between controlled variables with an increase in a desired electrical power output. The distributed control system may, for example, modify controlled variables to decrease a control rod insertion depth to increase reactor power and thermal input into the system; increase a circulator pump speed to increase heat transfer from the reactor and keep constant a reactor outlet temperature; increase a feedwater pump speed to increase heat transfer from the reactor; and increases a turbine control valve position to allow more steam into a turbine and to keep constant an outlet stream generator pressure. Similarly, the processor of the control system may observe that with a decrease in a desired electrical power output, the distributed control system may reverse these actions.

At step 204, the processor trains one or more models of the behavior of the distributed control system based on the monitored behavior of the distributed control system. In some implementations, the processor utilizes at least one of artificial intelligence or machine learning such as a feedforward neural network or linear regression to train the one or more models.

In some implementations, the processor trains only one model. In other implementations the processor trains multiple models. In implementations where the processor trains multiple models, the processor may train each model individually and then combine the multiple models into a control framework to provide optimal control strategies.

In some implementations, in training a model, a R-squared (R2), normalized root mean squared percent error (NRMSPE), and a mean absolute percent error (MAPE) metrics may be used to assess model performance.

After training one or more models, at step 206, the processor identifies, based on the one or more models, a subset of controlled variables of the set of controlled variables for optimization. In some implementations, the processor applies a test data set to the one or more models to identify the subset of controlled variable for optimization. The test data set may be data where one or more uncontrolled variables are incrementally changed in conjunction with desired targets. When the test data is applied to the one or more models, the processor obtains data showing how the distributed control system changes the controlled variables with the changes in uncontrolled variables to obtain the desired target and the variations in the monitored values as the controlled variables change.

In some implementations, the processor identifies the subset of controlled variables as the controlled variables that may be adjusted to meet a desired target given changes in uncontrolled variables while also minimizing variations in monitored variables. For example, in the context of a nuclear power plant, if a desired target is to maintain full power at the nuclear reactor when an ambient temperature significantly changes (an uncontrolled variable), the identified subset of controlled variables are the controlled variables that may be adjusted to maintain full power at the reactor with the change in ambient temperature while minimizing variations in monitored values such as a reactor temperature or pressure at the reactor. One of skill in the art will appreciate that by minimizing variations in monitored values such as reactor temperature or pressure at the reactor, the control system prevents monitored values from exceeding thresholds where safety or other types of procedures are initiated that may disrupt power output at the nuclear power plant facility.

At step 208, the processor monitors a behavior of the industrial facility without utilization of the distributed control system with respect to at least the subset of controlled variables. In some implementations, the processor applies a test data set to models of behavior of the facility without the distributed control system where in the data set, uncontrolled variables are incrementally changed or perturbed, and the resulting behavior of the industrial facility, including the behavior of the subset of controlled variables and the monitored variables, is observed.

At step 210, the processor optimizes the subset of controlled variables based on the monitored behavior at step 208 to obtain a desired output during changes in the uncontrolled variables, while also minimizing variations in monitored variables.

In some implementations, the processor utilizes genetic programming to optimize the subset of controlled variables. Generally, genetic algorithms rely on biologically inspired operations such as mutation, crossover, and selection to intelligently find an optimal set of variables that, in the present application, minimize variation in values of the monitored.

In some implementations, to minimize variations in monitored variables, the processor may optimize the subset of controlled variables to maintain values of the monitored variables to be at least a predetermined amount from one or more thresholds. For example, the processor may optimize the subset of controlled variables to maintain a value of one of the monitored variables to be at least a defined amount from a first threshold of the one or more thresholds. In another example, the processor may optimize the subset of controlled variables to maintain a value of one of the monitored variables to be at least a percentage from a first threshold of the one or more thresholds. In a further example, the processor may optimize the subset of controlled variables to maintain a value of the monitored variables as values of the set of uncontrolled variables change.

At step 212, the processor executes a control system for the industrial facility based on the optimization of the subset of controlled variables. As desired targets are set, such as a power output of a nuclear power plant, the control system utilizes the optimized set of controlled variables to attain the desired target, while minimizing variations in the monitored variables, thereby preventing the monitored variables from exceeding thresholds that may implement procedures that may disrupt power output.

FIGS. 1 and 2, and the accompanying descriptions, describe a control system for an industrial facility that utilizes a control variable optimization framework having multi-variant control for a set of optimized controlled variables. As discussed above, control systems of the present disclosure are able to provide a desired target (e.g., electric output in a nuclear power plant) while minimizing a variation in selected monitored variables that must be kept within pre-established operational thresholds.

The foregoing disclosure has been set forth to illustrate the invention and is not intended to be limiting. Since modifications of the disclosed form and implementations incorporating the spirit and substance of the invention may occur to persons skilled in the art, the invention should be construed to include everything within the scope of the appended claims and equivalents thereof.

1. A method comprising:
monitoring, with a processor, a behavior of a distributed control system of an industrial facility with respect to at least a set of uncontrolled variables, a set of controlled variables, and a set of monitored variables;
training, with the processor, a model of the behavior of the distributed control system based on the monitored behavior of the distributed control system, the processor utilizing at least one of artificial intelligence or machine learning to train the model;
identifying, with the processor, based on the model, a subset of controlled variables of the set of controlled variables for optimization;
monitoring, with the processor, a behavior of the industrial facility without the use of the distributed control system with respect to at least the subset of controlled variables;
optimizing, with the processor, based on the monitored behavior of the industrial facility without the use of the distributed control system, the subset of controlled variables to obtain a target result and restrict variation of values of the set of monitored values during a change in one or more values of the uncontrolled variables; and
executing, with a processor, a control system for the industrial facility based on the optimization of the subset of controlled variables.

2. The method of claim 1, wherein optimizing the subset of controlled variables to obtain the target result and restrict variation of values of the set of monitored values during a change in one or more values of the uncontrolled variables comprises:
optimizing, with the processor, the subset of controlled variables to obtain the target result while preventing a value of one of the monitored variables from being at least a defined amount from a threshold.

3. The method of claim 1, wherein optimizing the subset of controlled variables to obtain a target result and restrict variation of values of the set of monitored values during a change in one or more values of the uncontrolled variables comprises:
optimizing, with the processor, the subset of controlled variables to obtain the target result while preventing a value of one of the monitored variables from being at least a percentage from a threshold.

4. The method of claim 1, wherein optimizing the subset of controlled variables to obtain a target result and restrict variation of values of the set of monitored values during a change in one or more values of the uncontrolled variables comprises:
optimizing, with the processor, the subset of controlled variables to obtain the target result and maintain values of the monitored variables during the change in one or more values of the uncontrolled variables.

5. The method of claim 1, wherein the set of uncontrolled variables comprises at least one of an ambient temperature, a condenser pressure, a low-pressure turbine efficiency, a high-pressure turbine efficiency, a steam generator tube opening, or a variable speed pump degradation.

6. The method of claim 1, wherein the set of controlled variables comprises at least one of a control rod position, a circulator speed, a feedwater pump speed, or a turbine control valve.

7. The method of claim 1, wherein the set of monitored variables comprises at least one of a reactor power level, an outlet reactor temperature, an inlet reactor pressure, an inlet reactor mass flow, a secondary side steam generator outlet temperature, a secondary side steam generator outlet pressure, or a secondary side steam generator inlet mass flow.

8. The method of claim 1, wherein training a model, with the processor, based on the monitored behavior of the distributed control system, the processor utilizing at least one of artificial intelligence or machine learning to train the model comprises:
determining a multivariate relationship between one or more variables of the set of controlled variables, the set of uncontrolled variables, and the set of monitored variables utilizing at least one of artificial intelligence or machine learning.

9. The method of claim 1, wherein the processor utilizes genetic programming to optimize, based on the monitored behavior of the industrial facility without the use of the distributed control system, the subset of controlled variables to obtain a target result and restrict variation of values of the set of monitored values during a change in one or more values of the uncontrolled variables.

10. The method of claim 1, wherein:
training a model, with the processor, based on the monitored behavior of the distributed control system comprises:
training a plurality of models, with the processor, based on the monitored behavior of the distributed control system, the processor utilizing at least one of artificial intelligence or machine learning to train the plurality of models; and
identifying, with the processor, based on the model, a subset of controlled variables of the set of controlled variables for optimization comprises:
identifying, with the processor, based on the plurality of models, the subset of controlled variables of the set of controlled variables for optimization.

11. A control system comprising:
a memory configured to store computer readable instructions; and
a processor configured to executed the computer readable instructions stored in the memory and to:
monitor a behavior of a distributed control system of an industrial facility with respect to at least a set of uncontrolled variables, a set of controlled variables, and a set of monitored variables;
train a model of the behavior of the distributed control system based on the monitored behavior of the distributed control system utilizing at least one of artificial intelligence or machine learning to train the model;
identify, based on the model, a subset of controlled variables of the set of controlled variables for optimization;
monitor a behavior of the industrial facility without the use of the distributed control system with respect to at least the subset of controlled variables;
optimize, based on the monitored behavior of the industrial facility without the use of the distributed control system, the subset of controlled variables to obtain a target result and restrict variation of values of the set of monitored values during a change in one or more values of the uncontrolled variables; and
execute a control system for the industrial facility based on the optimization of the subset of controlled variables.

12. The control system of claim 11, wherein to optimize the subset of controlled variables to obtain the target result and restrict variation of values of the set of monitored values during a change in one or more values of the uncontrolled variables, the processor is configured to:
optimize the subset of controlled variables to obtain the target result while preventing a value of one of the monitored variables from being at least a defined amount from a threshold.

13. The control system of claim 11, wherein to optimize the subset of controlled variables to obtain a target result and restrict variation of values of the set of monitored values during a change in one or more values of the uncontrolled variables, the processor is configured to:
optimize the subset of controlled variables to obtain the target result while preventing a value of one of the monitored variables from being at least a percentage from a threshold.

14. The control system of claim 11, wherein to optimize the subset of controlled variables to obtain a target result and restrict variation of values of the set of monitored values during a change in one or more values of the uncontrolled variables, the processor is configured to:
optimize the subset of controlled variables to obtain the target result and maintain values of the monitored variables during the change in one or more values of the uncontrolled variables.

15. The control system of claim 11, wherein the set of uncontrolled variables comprises at least one of an ambient temperature, a condenser pressure, a low-pressure turbine efficiency, a high-pressure turbine efficiency, a steam generator tube opening, or a variable speed pump degradation.

16. The control system of claim 11, wherein the set of controlled variables comprises at least one of a control rod position, a circulator speed, a feedwater pump speed, or a turbine control valve.

17. The control system of claim 11, wherein the set of monitored variables comprises at least one of a reactor power level, an outlet reactor temperature, an inlet reactor pressure, an inlet reactor mass flow, a secondary side steam generator outlet temperature, a secondary side steam generator outlet pressure, or a secondary side steam generator inlet mass flow.

18. The control system of claim 11, wherein to train a model, based on the monitored behavior of the distributed control system, utilizing at least one of artificial intelligence or machine learning to train the model, the processor is configured to:
determine a multivariate relationship between one or more variables of the set of controlled variables, the set of controlled variables, and the set of monitored variables utilizing at least one of artificial intelligence or machine learning.

19. The control system of claim 11, wherein the processor is configured to utilize genetic programming to optimize, based on the monitored behavior of the industrial facility without the use of the distributed control system, the subset of controlled variables to obtain a target result and restrict variation of values of the set of monitored values during a change in one or more values of the uncontrolled variables.

20. The control system of claim 11, wherein:
to training a model based on the monitored behavior of the distributed control system, the processor is configured to:
training a plurality of models, based on the monitored behavior of the distributed control system utilizing at least one of artificial intelligence or machine learning to train the plurality of models; and
to identify, based on the model, a subset of controlled variables of the set of controlled variables for optimization, the processor is configured to:
identify, based on the plurality of models, the subset of controlled variables of the set of controlled variables for optimization.
